(19) United States
(12) Patent Application Publication
(10) Pub. No.: US 2010/0107184 A1
(43) Pub. Date: Apr. 29, 2010

(54) TV with eye detection

(76) Inventor: Peter Rae Shintani, San Diego, CA (US)

Correspondence Address: MILLER PATENT SERVICES, 2500 DOCKERY LANE, RALEIGH, NC, 27606, US

(21) Appl. No.: 12/288,823

(22) Filed: Oct. 23, 2008

(51) Int. Cl. H04N 7/16

(52) U.S. Cl. 725/10

(57) ABSTRACT

In certain implementations consistent with the present invention, a method for monitoring a television system viewer's status involves monitoring a field of view encompassing a viewer environment using a camera sensitive to light in the infrared (IR) spectrum; identifying a pair of bright spots in the IR spectrum that are spaced by a spacing consistent with spacing of a pair of human eyes; monitoring at least one characteristic of the spots to ascertain a status of a television system viewer; and at the television system, taking an action that affects an operational characteristic of the television system on the basis of the ascertained status of the television system viewer. This abstract is not to be considered limiting, since other embodiments may deviate from the features described in this abstract.

### COPYRIGHT AND TRADEMARK NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever. Trademarks are the property of their respective owners.

### BACKGROUND

Television (TV) devices have been proposed that use pattern recognition to detect whether or not a viewer has fallen asleep. However, pattern recognition techniques are complex and computationally intensive and may thus be costly to actually implement.

### BRIEF DESCRIPTION OF THE DRAWINGS

Certain illustrative embodiments illustrating organization and method of operation, together with objects and advantages may be best understood by reference detailed description that follows taken in conjunction with the accompanying drawings in which:

FIG. 1 is a diagram illustrating an example television system having a video camera consistent with certain embodiments of the present invention.

FIG. 2 is an example flow chart of a process consistent with certain embodiments of the present invention.

FIG. 3 is a flow chart of an example process for viewer monitoring for sleep detection consistent with certain embodiments of the present invention.

FIG. 4 is a flow chart of an example process for viewer monitoring for image angle adjustment consistent with certain embodiments of the present invention.

FIG. 5 is an illustration of image angle adjustment consistent with certain embodiments of the present invention.

FIG. 6 is a flow chart of an example process for viewer monitoring for image angle adjustment for multiple viewers consistent with certain embodiments of the present invention.

FIG. 7 is an illustration of an image angle adjustment consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically. The term “program” or “computer program” or similar terms, as used herein, is defined as a sequence of instructions designed for execution on a computer system. A “program”, or “computer program”, may include a subroutine, a function, a procedure, an object method, an object implementation, in an executable application, an applet, a servlet, a source code, an object code, a shared library/dynamic load library and/or other sequence of instructions designed for execution on a computer system.

The term “program”, as used herein, may also be used in a second context (the above definition being for the first context). In the second context, the term is used in the sense of a “television program”. In this context, the term is used to mean any coherent sequence of audio video content such as those which would be interpreted as and reported in an electronic program guide (EPG) as a single television program, without regard for whether the content is a movie, sporting event, segment of a multi-part series, news broadcast, etc. The tern may also be interpreted to encompass commercial spots and other program-like content which may not be reported as a program in an electronic program guide.

Reference throughout this document to “one embodiment”, “certain embodiments”, “an embodiment”, “an example”, “an implementation” or similar terms means that a particular feature, structure, or characteristic described in connection with the embodiment, example or implementation is included in at least one embodiment, example or implementation of the present invention. Thus, the appearances of such phrases or in various places throughout this specification are not necessarily all referring to the same embodiment, example or implementation. Furthermore, the particular features, structures, or characteristics may be combined in any suitable manner in one or more embodiments, examples or implementations without limitation.

The term “or” as used herein is to be interpreted as an inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

As noted above, television (TV) devices have been proposed that use pattern recognition to detect whether or not a viewer has fallen asleep. However, pattern recognition techniques are complex and computationally intensive and may thus be costly to actually implement.

Detection of the state of a viewer can allow the TV to save energy and/or add to user convenience. The television device can be adapted to detect a state of attention it is receiving from the viewers and modify its operational state or the operational state of associated or integrated devices such as Personal Video Recorders (PVRs—sometimes call Digital Video Recorders or DVRs) accordingly. Hence, use of the term “operational characteristic of the television system” herein refers not only to a particular state of the television itself, but can also be interpreted to mean an operational characteristic of any component of the television system including a set top box (STB), set back box (SBB), Point of Deployment module (POD) or a PVR or other recording or playback device (internal or external to the TV). By way of example, and not limitation, detection of a person falling asleep while watching a TV program can cause a PVR to begin recording or pausing playback, or a time stamp function can be used to identify a point in time in the programming for ease of retrieval at a later time to resume watching.

Many people commonly multi-tasks when trying to watch TV and/or fall asleep while trying to watch TV. This can result in body discomfort from sleeping on a couch or having to remember where one stopped paying attention to the program. Monitoring the viewer's state of attention can be useful in modification of the TV's operation and thus adapting the TV to the state of the viewer's attention or even the position in which the user is situated in viewing the TV.

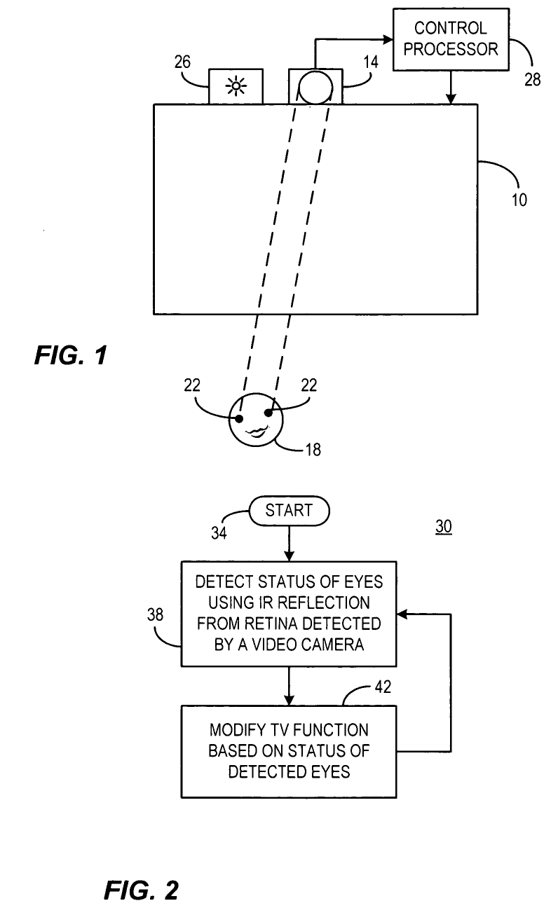

Referring to FIG. 1, in order to make the television such as 10 more intelligent, a camera 14 can be incorporated into the display. Camera 14 is shown above the display of TV 10 for clarity of illustration, but it is noted that the location of the camera will be more aesthetically pleasing if integrated into the television system cabinet in some way. The camera should capture an image encompassing a field of view that would be occupied by viewers of the television system 10. It is noted that the human face 18 and eyes 22 are very consistent when one examines the eye spacing, and infra-red reflective properties. Even a low resolution camera, if assisted by infra red (IR) lighting that illuminates the field of view captured by the camera 14, either ambient or from lighting source 26 can easily detect the reflection from a viewer's eyes. In fact, the reflection of IR light from a human's pupils is extremely intense and is normally filtered out by modern video cameras. By very rudimentary image processing using a processor depicted as 28 (again depicted outside the television system for convenience of illustration), and by averaging the time that the camera sees a consistent reflective pattern consistent with a pair of human eyes 22, it can discern that a person is actively watching the TV display 10. If the viewer's attention deviates from the TV for more than a pre-determined period of time (say, several minutes) and/or if the amount of reflection varies and then diminishes the display can assume that in the former the person is watching something other than the TV, and in the latter, the person has likely fallen asleep.

The spacing of actual human eyes can be calibrated for a particular room and a particular set of viewers so as to improve accuracy of the processes discussed herein by causing the camera system to take note of the actual eye spacing at a range of distances for the most likely viewers of the television system. The spacing of human eyes (center to center) averages approximately 64 mm and ranges from roughly 46 mm to roughly 76 mm as will be discussed later. If distance from the camera to the face can be approximated (which is possible with technology similar to that used for focusing an automatically focusing camera, then eye spacing can also be approximated so as to distinguish between human eyes and other objects. However, as previously noted, the IR reflection from human retinas is extremely intense when captured by a video camera (e.g., one using charge coupled devices CCDs or CMOS sensors) and can be readily identified if there are two such bright spots within a prescribed number of pixels or one another, even if absolute distance is not known.

Others have tried to add functionality with a camera on a display, but typically it involves complex image and pattern recognition, to discern facial expressions and or hand gestures. However, the functionality discussed herein can be added with minimal cost and complexity. Depending upon how the user has instructed the television system and the programming of the television system, when the person's attention was diverted from the display, the TV could take any number of actions included but not limited to turning “off” or if system control is available pausing the content or starting recording of the content if it is a live broadcast in order to preserve the content for retrieval at a later time. Many variations of actions that can be taken are possible once a determination is made as to the status of the user. For purposes of this document, TV actions are to be considered not only direct actions of a television receiver, but could also encompass actions associated with recording and playback devices used with the TV. Several examples are presented in detail herein, but are not to be considered limiting since detection of the user state can be used to trigger many actions including but not limited to those specific actions discussed in detail herein.

In one example implementation, if analysis of the user's eyes indicates that the viewer has fallen asleep, the TV could be instructed via a programmed processor to reduce the volume and/or picture brightness gradually and then go into a “standby” or “sleep” mode (i.e., the mode a user generally considers to be “off”). Such actions would generally make for a transition that goes unnoticed by the sleeping individual and thereby encourages continued sleep rather than potentially awakening the sleeping individual should the volume suddenly increase (e.g., with tones from an emergency broadcast test or change in volume as a result of newly encountered highly compressed audio in a television program. In another example, if the viewer wishes, after a predetermined period of “sleep” the display could try to awaken the viewer by turning back on, and or sending out visual or audible alarm messages.

The system could also carry out range measurements. That is, assume that the typical viewer's intraocular spacing is a given distance. The system can then roughly approximate the viewer's distance from the display. Hence the TV system could vary a level of image enhancement based upon the viewing distance. The TV system could also adjust the lip sync so that it compensates for audio delay with respect to the appearance of the video to the viewer. Other adjustments could also be made. For example, if the plane of the viewer's eyes is rotated from the horizontal position (as in the case of a viewer viewing the TV while lying on the floor, the TV could rotate its display, so that the viewer can see the picture in the correct orientation. If there is no default for the direction of orientation, perhaps the TV could track the direction of orientation of the viewers' eyes so that it can determine and execute an automatic rotation the display.

In one method of implementing this system a camera and possibly infra red lighting apparatus 26 is embedded into the TV system 10 as previously noted. Placement of the camera 14 and light apparatus 26 in the bezel, preferably the top edge, may reduce the potential for the camera from being obscured.

FIG. 2 shows a basic example process 30 implemented in accord with certain embodiments consistent with the present invention starting at 34. At 38, the status of one or more user's eyes is monitored by a camera that is sensitive to infrared light (which may be supplied by the television system). Detection of the eyes can be by virtue of detection of two bright spots of reflected light in the infrared spectrum that are separated by a distance within the normal range of separation of human eyes (assume for now approximately 46 to 76 mm). By detection and analysis of the characteristics of the detected pair or pairs of eyes, the TV's function can be modified based upon the state of the eyes detected at 42.

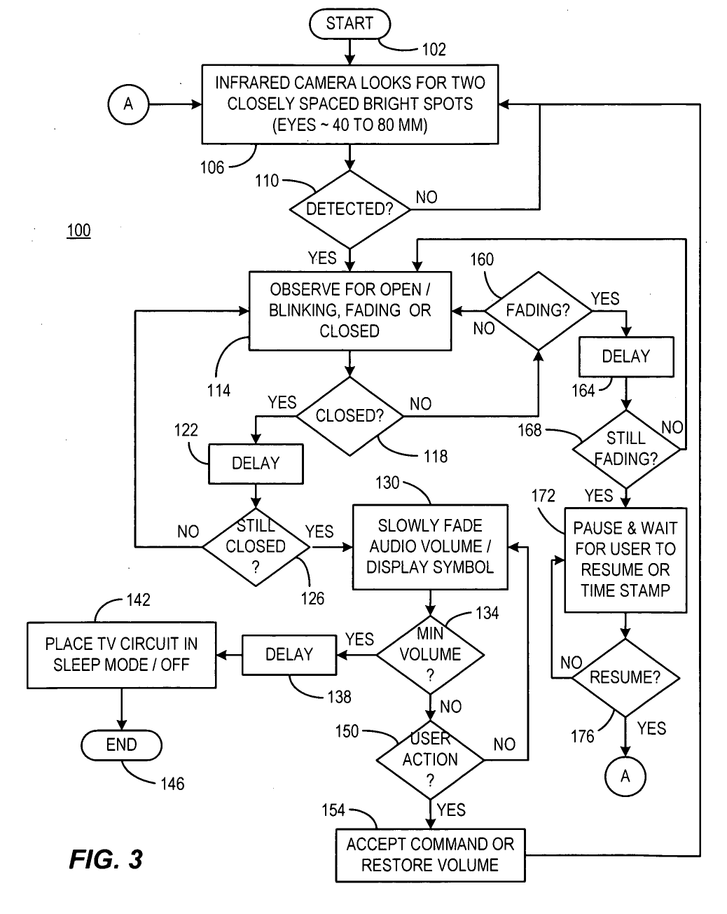

One more detailed implementation is depicted in process 100 of FIG. 3 starting at 102 after which the image from infrared camera 14 is analyzed by one or more internal processors to attempt to identify two bright spots in the field of view that are closely spaced in the infrared spectrum at 106. By closely spaced we mean, spaced consistently with the spacing of a pair of human eyes.

Authorities disagree on an exact range of spacing of human eyes (known as Pupillary Distance or PD). When an ophthalmologist and an optician were consulted, one indicated that the PD for a child could be as low as 45 mm while the other indicated a low of about 46 mm. At the upper end, a large adult was indicated to be as large as 75 or 76 mm. Authorities such as Wikipedia currently indicate that PD typically range from 41-55 mm for a child and typically 54-68 mm for adults but generally range from 48 to 73 mm. Other authorities indicate that an average PD is approximately 54-70 mm. With this information as rough guidance, it will be presumed that the spacing can be within the range of about 45 to about 75 mm, or roughly 40 to 80 mm or within a user calibrated range. The degree of resolution of the video camera need not be great, and the measurement can be either taking into consideration a range measurement or can be based upon an assumption of a range of possible viewing distances, or can be manually adjusted or calibrated.

If a pair of high brightness spots with proper spacing is detected at 110, the processor 28 can generally presume that a pair of human eyes has been detected. At this point, the eye images can be analyzed at 114 for any useful characteristic that can be used to manipulate the operation of the television system 10. In this example, the analysis involves observing the eyes over a period of time to determine if the eyes remain open, are blinking, fading or closed. These characteristics can be associated with an awake state of the viewer if the eyes are open and occasionally blinking; if the brightness is fading, the viewer may be diverting attention from the television system or falling asleep and if the eyes are closed, the viewer can be presumed to have left the room or be asleep. Various actions can be taken as a result of this analysis, and the example process 100 is but one example.

In this example, if the processor 28 determines that the user is asleep because the eyes have closed at 118 (or the user has left the room), the system may first delay any action for a period of time at 122 to assure that a correct action is to be taken. (Note that other actions may be appropriate such as beginning to record a received broadcast program so that the viewer can pick up viewing at a later time.) If the eyes are still close after the delay (e.g., several minutes—perhaps in the range of 2-10 minutes, which can be user set) at 126, it can be safely presumed that the viewer has fallen asleep or left the room (Note that children with a short attention span may simply leave without regard for the energy consumption of a television system). In this case, recording may begin if it has not already. Additionally, on the assumption that the viewer has fallen asleep, the audio volume and/or the video brightness can begin to slowly fade at 130 so as to not create a sudden change in audible and/or visual environment that might awaken the viewer. (In other example implementations, the user may wish to be assisted in staying awake, in which case, an audible alarm can sound, etc.).

In the example shown in 100, when the volume is at the minimum (and/or the brightness is at minimum) at 134, either with or without an additional delay at 138 the TV system can be placed in a “sleep”, “standby” or “off” mode at 142 (i.e., the mode or state that most TVs are in at the time when they are switched to the “on” mode) which consumes far less energy than the “on” state or mode. Once the TV system is “off” or “asleep” or in “standby” mode, the process ends at 146 until the user turns the television back “on”. The user can be prompted at this point to either resume a recorded version from the point that the program being watched ended, or can make another selection as desired. Many variations are possible including taking any number of “record” or “playback” related actions.

In the event minimum volume is not reached at 134 and no user action is taken to intervene at 150, the volume will continue to fade and/or the picture brightness will continue to diminish at 130. However, if the user awakens, or discovers that the TV system has detected that he or she is falling asleep (e.g., by a displayed symbol at 130), the user can intervene with any suitable action at 150. For example, pressing any remote control key at 150 can serve to indicate to the television that it is to remain in the full “on” mode. Such commands are accepted at 1 54 and the process returns to 106. In another example, such command may disable the eye detection processes at 154. In other examples, any command other than an “off” command can result in resumption of the TV to full “on”. Many variations will occur to those skilled in the art upon consideration of the present teachings.

Another feature can result if the processor detects at 114 that the user's attention is fading at 114. This can be determined if the user is reading with the TV system “on”, is dozing off to sleep or is engaged in conversation with another person or is frequently looking away. It can be deduced from these actions that the user's attention is not fully devoted to the television program at 160 and is deemed to be “fading”. As in the determination of sleep previously made, it may be desirable to delay at 164 for a time to determine if the viewer's attention is still fading at 168. If not, observation can continue at 114 in either 160 or 168. In this example, the action taken is to enter a pause mode of a playback device (or begin recording to a digital video recorder (DVR)) and/or time stamp the content so that it can be resumed at the same location at a later time at 172 and await manual intervention for the user to resume at 176. The process then returns to 106 or halts to await a manual intervention.

It is noted that the present example implementations presume that the viewer is alone and only one set of eyes can be detected. In this instance, it will be apparent that if multiple sets of eyes are detected, the actions taken would likely be most advantageously applied to the last remaining set of eyes. Thus, if three people are watching a television program and two go to sleep, fading the volume and brightness is likely inappropriate unless the third begins to go to sleep. However, beginning a recording of the content may be advantageously begun upon detection of the first to go to sleep so that all viewers can at some point complete viewing the television program. Many variations will occur to those skilled in the art upon consideration of the present teachings.

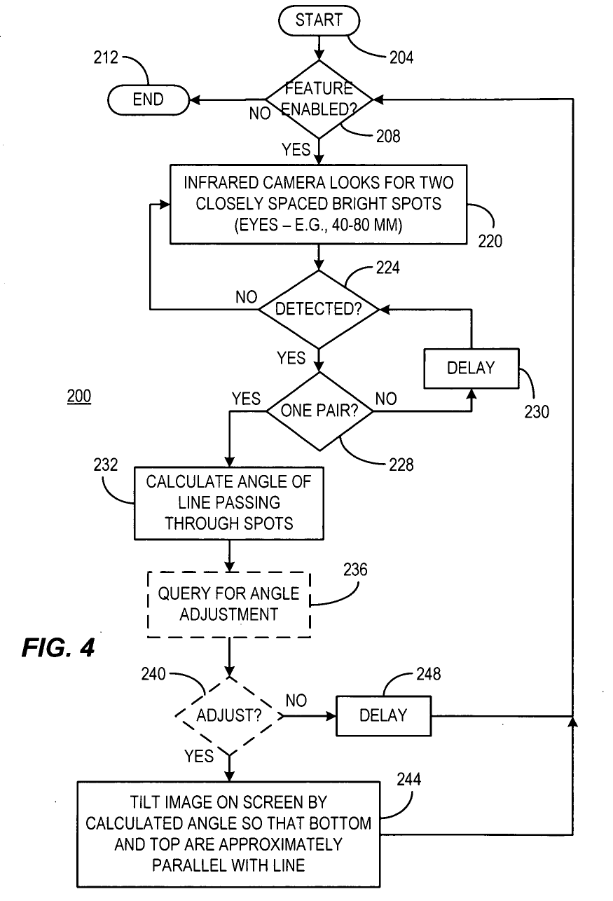

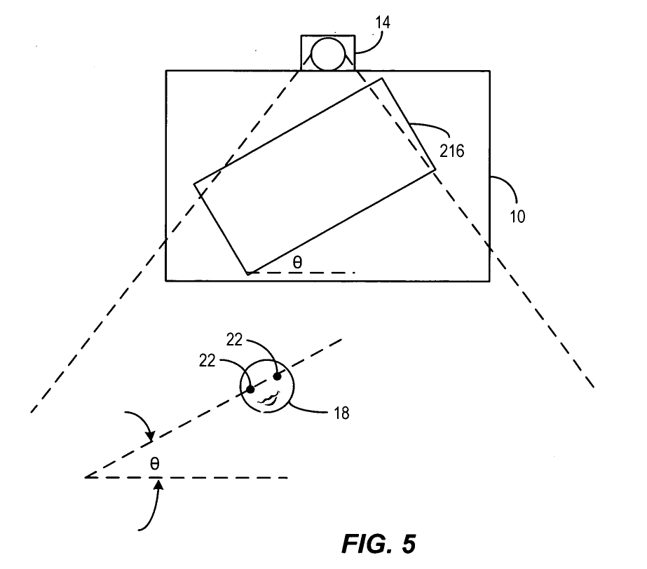

Another example action that can be taken based on the IR camera detection of eyes 22 of a view 18 is depicted as process 200 of FIG. 4 which is most instructive when viewed in conjunction with FIG. 5. Process 200 starts at 204, where at 208 (as may be the general case) processor 28 makes a determination if any particular feature is enabled prior to proceeding to an analysis. If the feature is not enabled, the process ends at 212 until the user enables a particular feature. In this case, the example feature is an image tilt as illustrated in FIG. 5 where the image 216 is adjusted to match an angle θ in which the viewer's eyes 22 align referenced to the horizontal (or alternatively vertical). In this example, the viewer might be lying on the floor watching TV with his head 18 propped on his arm or a pillow such that his eyes are at an angle θ to the horizon. Hence, at 220, the infrared camera looks for two bright spots in the IR frequency range. As the process proceeds, the spots will be analyzed to determine if they are outside a specified angle from the horizontal (e.g., more than a 20 degree difference for example).

Once the eyes are detected, in this example at 224, and possibly verified by multiple detections, in this example process the process determines that there is only one set of eyes at 228. If not, the process waits until only one set of eyes are present at 230. If one pair of eyes is present at 228, the angle of a line passing through the eyes is approximated at 232. If not, the process returns to 224 after a delay at 230 In this example, angle adjustment is only possible if a single set of eyes is present that meets the criteria for adjustment and then the adjustment will only be made upon query at 236 for approval of the adjustment and a positive response to the query at 240. If a positive response is received at 240, the image 216 can be tilted on screen under control of the processor 28 at 244 so as to more closely align the screen with the alignment of the viewer's eyes. On a negative response from the viewer, a suitable delay can be imposed at 248 and control returned to 208 so as to not continually annoy the viewer with queries. Alternatively, the feature can be disabled on receipt of a negative response at 240.

Clearly, the feature disclosed in FIGS. 4-5 are most useful with a single viewer, and the feature can be automatically disabled if a second viewer enters the camera's field of view in other embodiments. However, by use of more complex processing, this and other features can be expanded to encompass multiple viewers—as previously discussed in connection with determining whether to begin taking an action based upon a first to go to sleep or a last to go to sleep. In this illustration, it is noted that 236 and 240 are shown in dashed lines to indicate that this or other features can be implemented without need for user confirmation if desired.

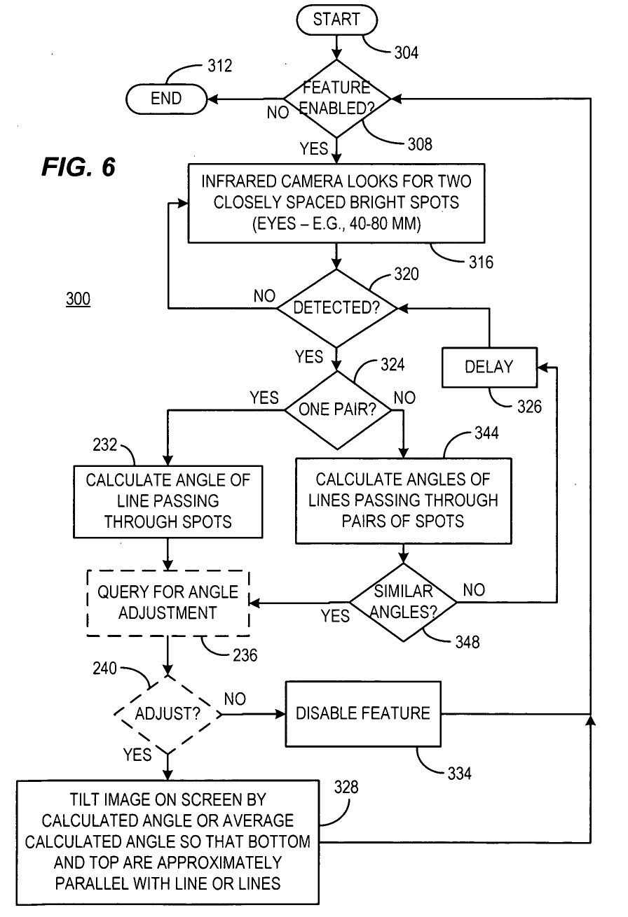

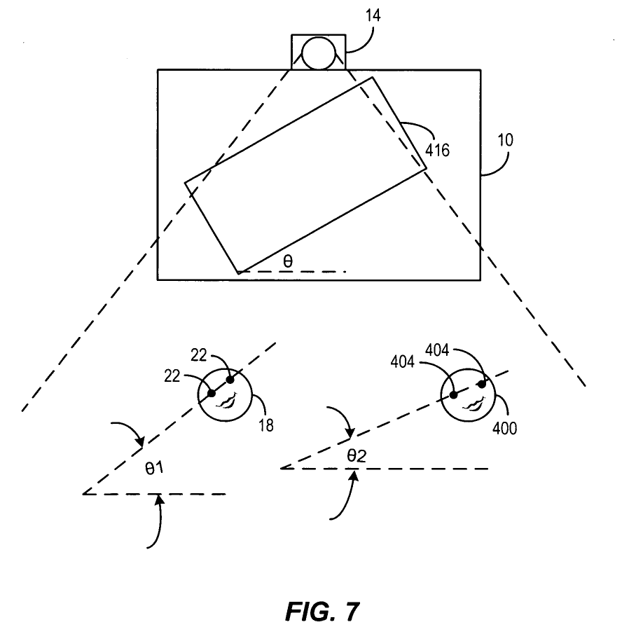

In FIGS. 6-7, an illustrative process 300 is depicted wherein the tilt function is adapted to multiple viewers. Similar or varying logic can be applied to use of the eye detection information for control and manipulation of many features, with this example provided for illustrative purposes only. The process begins at 304 after which the process determines if the feature is enabled at 308. If not the process ends at 312 as described previously. The camera and processor again look for pairs of eyes at 316 consistent with human eyes until detected at 320.

Once detected, if a single pair of eyes is present at 324, the angle of a line passing through the eyes is calculated at 232 and the viewer is queried to adjust the tilt as previously at 236. If the user agrees at 240, the image is tilted as previously described at 328 (here the average is the same as the angle). However, in this example, if the user declines to adjust at 240, the feature is disabled at 334 and in either case, control return to 308.

If multiple sets of eyes are detected, in one implementation, the feature will be automatically disabled. However, other possibilities exist. For example, if multiple sets of eyes are detected at 324 it is easy to calculate an approximate angle for each set of eyes at 344. If all eye angles are similar enough (e.g., within about 20 degrees for example) as determined at 348, it is still possible that the viewers may wish to view with the adjusted angles. Control can thus be passed to 236 as before, with the tilt of the image on the screen determined by, for example, an average of the angles at 328. If the angles are not similar at 348, control can be returned to 320 after a delay at 326. Thus, as depicted in FIG. 7, viewer 18 may have eyes 22 oriented at angle θ1 and a second viewer 400 may have eyes 404 oriented at angle θ2. In this case, the average of θ1 and θ2 (θ) is used to adjust the tilt of image 416 on the display.

While not shown in any of the processes, it will be clear that radical changes to the state of operation of the television system should likely be temporary and revert back to normal operation at a suitable time such as initial power up, or when elected by the user. Other variations will occur to those skilled in the art upon consideration of the present teachings.

However, it is reiterated that use of an Infrared sensitive camera produces a very bright set of images representing reflection from the back of a viewer's eyes. This fact makes complex image processing unnecessary in many instances since the images are so bright and constrained to a spacing that can be determined from the image that recognition of the eyes and their state can be accomplished readily using simple processing. Once detected and processed as desired, those skilled in the art will appreciate that many functions from sleep detection, image tilt and other functions can be readily provided.

Hence, in certain embodiments, a method of switching a television to a sleep/pause mode can be implemented based on viewer's attention. A camera, possibly assisted by infra red (IR) lighting, receives reflections from viewer's eyes. Based on the received reflection pattern, viewer's state of attention is determined. Accordingly, the television can be switched to a “sleep” or a “pause” mode. In another aspect, a method of measuring the distance of viewer from the television display screen can be implemented using a camera assisted by IR. The distance of viewer from the television display screen can be estimated, for example, as a function of viewer's pupillary spacing as received by the camera or by focus technology. The television can vary the level of image enhancement based on the determined distance. In yet another aspect, the television can determine the orientation of the plane of the viewer's eyes with the help of camera assisted IR. Accordingly, the television display screen can be rotated to align with the plane of viewer's eyes. Other variations are also possible.

While the spacing of the eyes varies from roughly 40 to 80 mm, the average adult eye spacing is approximately 64 mm. Using this number or using a calibration process, the spacing determined by the bright spots appearing on the IR camera image can be used to gauge the distance a viewer is from the display and make appropriate adjustments to the screen image. One example might be image size, which can be reduced if the viewer is close or expanded if the viewer is farther away. Similarly, brightness or sharpness can be adjusted based upon the viewer's approximate distance. Many variations are possible upon consideration of the present teachings.

It is note that the camera 14 is depicted in some illustrations with and without the processor 28 and IR light source 26, but the processor is understood to be present and an IR light source may also be present. It is further noted that to enhance the ability of a conventional video camera to zero in on reflected IR light from the eyes; it may be advantageous in some applications to provide IR filtering as either an optical filter or as an electronic filter. Since most solid state image sensors have inherently high sensitivity to IR light, an IR filter is generally placed in front of such sensors to filters and thereby reduce the effects of such IR light on an image. Such filtering is not used in certain implementations, or the filtering can be such that only IR light passes through. In other implementations, a variable IR filter can be used so that the image sensor can operate in multiple modes—with and without IR filtering, or multiple sensors (with or without IR filtering) can be used. This can lead to various implementations wherein an IR filtered sensor can be used for crude (or more complex) pattern matching to locate a viewer or verify the location of a viewer. This information can be used in conjunction with IR location of the eyes as described. The IR filtering can be either mechanically moved for a single sensor or in a multiple sensor environment, the information from filtered and unfiltered sensors can be alternated. Other variants will occur to those skilled in the art upon consideration of the present teachings.

Thus, a method for monitoring a television system viewer's status involves monitoring a field of view encompassing a viewer environment using a camera sensitive to light in the infrared (IR) spectrum; identifying a pair of bright spots in the IR spectrum that are spaced by a spacing consistent with spacing of a pair of human eyes; monitoring at least one characteristic of the spots to ascertain a status of a television system viewer; and at the television system, taking an action that affects an operational characteristic of the television system on the basis of the ascertained status of the television system viewer.

In certain implementations, the at least one characteristic comprises at least one of fading characteristics, blinking characteristics and disappearing characteristics. In certain implementations, the at least one characteristic comprises an orientation of the bright spots. In certain implementations, the method further involves illuminating the field of view captured by the camera with light in the infrared spectrum. In certain implementations, the spacing encompasses at least a portion of the range of 40 to 70 mm. In certain implementations, the spacing is interpreted as an indication of range of the viewer from the camera. In certain implementations, the at least one characteristic is interpreted as an indication that the viewer is asleep, and wherein the action comprises fading an audio volume of the television system. In certain implementations, the at least one characteristic is interpreted as an indication that the viewer is asleep, and wherein the action comprises fading reducing a video brightness of the television system. In certain implementations, the at least one characteristic is interpreted as an indication that the viewer is asleep, and wherein the action comprises placing the television system in a “standby”, “sleep” or “off” mode; or storing a time stamp associated with the program being viewed. In certain implementations, the at least one characteristic comprises a tilt angle of the spots. In certain implementations, the action comprises adjusting an angle of tilt of an image displayed on the television system. In certain implementations, the action comprises starting, stopping or pausing a recording process; or storing a time stamp associated with the program being displayed.

Another method for monitoring a television system viewer's status involves monitoring a field of view encompassing a viewer environment using a camera sensitive to light in the infrared (IR) spectrum; illuminating the field of view captured by the camera with light in the infrared spectrum; identifying a pair of bright spots in the IR spectrum that are spaced by a spacing consistent with spacing of a pair of human eyes, wherein the spacing encompasses at least a portion of the range of 40 to 70 mm; monitoring at least one characteristic of the spots to ascertain a status of a television system viewer, wherein the at least one characteristic comprises at least one of fading characteristics, blinking characteristics, disappearing characteristics and orientation characteristics; and at the television system, taking an action that affects an operational characteristic of the television system on the basis of the ascertained status of the television system viewer, wherein the at least one characteristic is interpreted as an indication that the viewer is asleep, and wherein the action comprises fading an audio volume of the television system one characteristic is interpreted as an indication that the viewer is asleep, and wherein the action further comprises fading reducing a video brightness of the television system and further comprising placing the television system in a “standby”, “sleep” or “off” mode when the audio volume and video brightness are reduced.

In certain implementations, the spacing is interpreted as an indication of range of the viewer from the camera. In certain implementations, the at least one characteristic comprises a tilt angle of the spots. In certain implementations, the action comprises adjusting an angle of tilt of an image displayed on the television system. In certain implementations, the action comprises starting, stopping or pausing a recording process; or storing a time stamp associated with the program being displayed.

A tangible computer readable electronic storage medium can store instructions which, when executed on one or more programmed processors, carry out any of the methods described above.

A television system apparatus that monitors a television system viewer's status consistent with certain embodiments has a camera that monitors a field of view in the infrared (IR) spectrum that encompasses a viewer environment. One or more processors identify a pair of bright spots in the field of view that are spaced by a spacing consistent with spacing of a pair of human eyes. The one or more processors monitor at least one characteristic of the spots to ascertain a status of a television system viewer. The one or more processors take an action that affects an operational characteristic of the television system on the basis of the ascertained status of the television system viewer.

In certain implementations, the at least one characteristic comprises at least one of fading characteristics, blinking characteristics and disappearing characteristics. In certain implementations, the at least one characteristic comprises an orientation of the bright spots. In certain implementations, a source of IR light illuminates the field of view captured by the camera. In certain implementations, the spacing encompasses at least a portion of the range of 40 to 70 mm. In certain implementations, the at least one characteristic is interpreted as an indication that the viewer is asleep. In certain implementations, the action comprises at least one of fading an audio volume of the television system, fading reducing a video brightness of the television system, and placing the television system in a “standby”, “sleep” or “off” mode. In certain implementations, the at least one characteristic comprises a tilt angle of the spots and wherein the action comprises adjusting an angle of tilt of an image displayed on the television system. In certain implementations, the action comprises starting, stopping or pausing a recording process; or storing a time stamp associated with the program being displayed.

Those skilled in the art will recognize, upon consideration of the above teachings, that certain of the above exemplary embodiments are based upon use of a programmed processor. However, the invention is not limited to such exemplary embodiments, since other embodiments could be implemented using hardware component equivalents such as special purpose hardware and/or dedicated processors. Similarly, general purpose computers, microprocessor based computers, micro-controllers, optical computers, analog computers, dedicated processors, application specific circuits and/or dedicated hard wired logic may be used to construct alternative equivalent embodiments.

Certain embodiments described herein, are or may be implemented using a programmed processor executing programming instructions that are broadly described above in flow chart form that can be stored on any suitable electronic or computer readable storage medium. However, those skilled in the art will appreciate, upon consideration of the present teaching, that the processes described above can be implemented in any number of variations and in many suitable programming languages without departing from embodiments of the present invention. For example, the order of certain operations carried out can often be varied, additional operations can be added or operations can be deleted without departing from certain embodiments of the invention. Error trapping can be added and/or enhanced and variations can be made in user interface and information presentation without departing from certain embodiments of the present invention. Such variations are contemplated and considered equivalent.

While certain embodiments herein were described in conjunction with specific circuitry that carries out the functions described, other embodiments are contemplated in which the circuit functions are carried out using equivalent executed on one or more programmed processors. General purpose computers, microprocessor based computers, micro-controllers, optical computers, analog computers, dedicated processors, application specific circuits and/or dedicated hard wired logic and analog circuitry may be used to construct alternative equivalent embodiments. Other embodiments could be implemented using hardware component equivalents such as special purpose hardware and/or dedicated processors.

While certain illustrative embodiments have been described, it is evident that many alternatives, modifications, permutations and variations will become apparent to those skilled in the art in light of the foregoing description.

What is claimed is:

1. A method for monitoring a television system viewer's status, comprising:
monitoring a field of view encompassing a viewer environment using a camera sensitive to light in the infrared (IR) spectrum;
identifying a pair of bright spots in the IR spectrum that are spaced by a spacing consistent with spacing of a pair of human eyes;
monitoring at least one characteristic of the spots to ascertain a status of a television system viewer; and
at the television system, taking an action that affects an operational characteristic of the television system on the basis of the ascertained status of the television system viewer.

2. The method according to claim 1, wherein the at least one characteristic comprises at least one of fading characteristics, blinking characteristics and disappearing characteristics.

3. The method according to claim 1, wherein the at least one characteristic comprises an orientation of the bright spots.

4. The method according to claim 1, further comprising illuminating the field of view captured by the camera with light in the infrared spectrum.

5. The method according to claim 1, wherein the spacing encompasses at least a portion of the range of 40 to 70 mm.

6. The method according to claim 5, wherein the spacing is interpreted as an indication of range of the viewer from the camera.

7. The method according to claim 1, wherein the at least one characteristic is interpreted as an indication that the viewer is asleep, and wherein the action comprises fading an audio volume of the television system.

8. The method according to claim 1, wherein the at least one characteristic is interpreted as an indication that the viewer is asleep, and wherein the action comprises fading reducing a video brightness of the television system.

9. The method according to claim 1, wherein the at least one characteristic is interpreted as an indication that the viewer is asleep, and wherein the action comprises placing the television system in a “standby”, “sleep” or “off” mode; or storing a time stamp associated with the program being viewed.

10. The method according to claim 1, wherein the at least one characteristic comprises a tilt angle of the spots.

11. The method according to claim 10, wherein the action comprises adjusting an angle of tilt of an image displayed on the television system.

12. The method according to claim 1, wherein the action comprises starting, stopping or pausing a recording process; or storing a time stamp associated with the program being displayed.

13. A tangible computer readable electronic storage medium storing instructions which, when executed on one or more programmed processors, carry out a method according to claim 1.

14. A method for monitoring a television system viewer's status, comprising:
monitoring a field of view encompassing a viewer environment using a camera sensitive to light in the infrared (IR) spectrum;
illuminating the field of view captured by the camera with light in the infrared spectrum;
identifying a pair of bright spots in the IR spectrum that are spaced by a spacing consistent with spacing of a pair of human eyes, wherein the spacing encompasses at least a portion of the range of 40 to 70 mm;
monitoring at least one characteristic of the spots to ascertain a status of a television system viewer, wherein the at least one characteristic comprises at least one of fading characteristics, blinking characteristics, disappearing characteristics and orientation characteristics; and
at the television system, taking an action that affects an operational characteristic of the television system on the basis of the ascertained status of the television system viewer, wherein the at least one characteristic is interpreted as an indication that the viewer is asleep, and wherein the action comprises fading an audio volume of the television system one characteristic is interpreted as an indication that the viewer is asleep, and wherein the action further comprises fading reducing a video brightness of the television system and further comprising placing the television system in a “standby”, “sleep” or “off” mode when the audio volume and video brightness are reduced.

15. The method according to claim 14, wherein the spacing is interpreted as an indication of range of the viewer from the camera.

16. The method according to claim 14, wherein the at least one characteristic comprises a tilt angle of the spots.

17. The method according to claim 16, wherein the action comprises adjusting an angle of tilt of an image displayed on the television system.

18. The method according to claim 14, wherein the action comprises starting, stopping or pausing a recording process; or storing a time stamp associated with the program being displayed.

19. A television system apparatus that monitors a television system viewer's status, comprising:
a camera that monitors a field of view in the infrared (IR) spectrum that encompasses a viewer environment;
one or more processors that identifies a pair of bright spots in the field of view that are spaced by a spacing consistent with spacing of a pair of human eyes;
the one or more processors monitoring at least one characteristic of the spots to ascertain a status of a television system viewer; and
the one or more processors taking an action that affects an operational characteristic of the television system on the basis of the ascertained status of the television system viewer.

20. The television system according to claim 19, wherein the at least one characteristic comprises at least one of fading characteristics, blinking characteristics and disappearing characteristics.

21. The television system according to claim 19, wherein the at least one characteristic comprises an orientation of the bright spots.

22. The television system according to claim 19, further comprising a source of IR light illuminating the field of view captured by the camera.

23. The television system according to claim 19, wherein the spacing encompasses at least a portion of the range of 40 to 70 mm.

24. The television system according to claim 19, wherein the at least one characteristic is interpreted as an indication that the viewer is asleep.

25. The television system according to claim 24, and wherein the action comprises at least one of fading an audio volume of the television system, fading reducing a video brightness of the television system, and placing the television system in a “standby”, “sleep” or “off” mode.

26. The television system according to claim 17, wherein the at least one characteristic comprises a tilt angle of the spots and wherein the action comprises adjusting an angle of tilt of an image displayed on the television system.

27. The television system according to claim 19, wherein the action comprises starting, stopping or pausing a recording process; or storing a time stamp associated with the program being displayed.
